(19) United States
(12) Patent Application Publication
(10) Pub. No.: US 2011/0000879 A1
(43) Pub. Date: Jan. 6, 2011

(54) METHOD OF MANUFACTURING A MASTER INFORMATION CARRIER FOR MAGNETIC TRANSFER AND A METHOD OF MANUFACTURING A MAGNETIC RECORDING MEDIUM

(75) Inventor: Satomi Kajiwara, Nagano (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO., LTD., Tokyo (JP)

(21) Appl. No.: 12/829,747

(22) Filed: Jul. 2, 2010

(30) Foreign Application Priority Data
Jul. 2, 2009 (JP) 2009-157893

(51) Int. Cl. G11B 5/84

(52) U.S. Cl. 216/22; 427/130; 156/272.2

(57) ABSTRACT

A method of easily manufacturing a master disk for magnetic transfer is disclosed. The method of the invention facilitates separation of the master disk and a slave disk to be transferred even after conducting a magnetic transfer process after adhering the two disks by pressing or exhaustion for the purpose of enhancing transfer performance. A method of manufacturing a master disk comprises a step of forming recesses by eliminating selected parts of a surface region of soft magnetic layer 20 that is uniformly formed on the surface of substrate 10, to a depth not to cut apart the parts with one another, and a step of transforming recessed parts 20b to a nonmagnetic or low magnetic state. The steps forms a pattern of protrusions 20a and recesses 20b corresponding to information to be magnetically transferred, the protrusions 20a being magnetic and the recesses 20b being nonmagnetic or low magnetic.

### BACKGROUND OF THE INVENTION

A. Field of the Invention

The present invention relates to a method of manufacturing a master information carrier for magnetic transfer and a method of manufacturing a magnetic recording medium to which necessary information is magnetically transferred using the master information carrier. The present invention relates, in particular to a method of manufacturing a master information carrier for magnetic transfer that easily transfers a magnetic information pattern such as preformat information to a magnetic recording medium used in hard disk devices. The present invention also relates in particular to a method of manufacturing a magnetic recording medium that records the preformat information and the like by a magnetic transfer process using the master information carrier for magnetic transfer.

B. Description of the Related Art

A magnetic recording medium (a hard disk) used in hard disk drives rapidly wide-spreading recently needs to be written with preformat information including servo information and address information for positioning a magnetic head. Although the writing process can be carried out after assembling the medium in the drive using a magnetic head, it is efficient and favorable to transfer the whole information collectively at once using a master information carrier (also referred to as a master disk) containing the written servo information and address information. In the following description, a magnetic recording medium to which the information is transferred from a master disk is also referred to as a magnetic recording medium to be transferred or as a slave disk.

The transfer process is generally carried out by a magnetic transfer process using magnetism. In the magnetic transfer process, a master disk and a magnetic recording medium to be transferred (a slave disk) are brought into close contact and a transferring magnetic field is applied by a magnetic field generating means such as an electromagnet device or a permanent magnetic device disposed on one side or both sides of the adhered article thereby magnetically transfer (also referred to simply as “transfer”) a magnetization pattern carrying information (such as servo signals) possessed by the master disk to a slave disk.

The magnetic transfer process has advantages that the recording can be conducted statically without changing the relative position between the master disk and the slave disk and that the recording process takes extremely short time.

In particular, patterning has become possible to transform the servo information into signals with the shortest bit length of 10 nm or shorter owing to progress in micro machining technologies represented by the electron beam writing technology in recent years. As a result, the magnetic transfer has had a capability to collectively write the signals comparable to the planar density of the hard disks to date.

A variety of magnetic transfer techniques have been proposed previously. Japanese Unexamined Patent Application Publication No. H10-040554, for example, discloses a collectively transfer method from a master disk that has a pattern of protrusions and recesses corresponding to information signals formed on the surface of a magnetic layer on a substrate. Japanese Unexamined Patent Application Publication No. H10-269566 discloses a method for improving the adhering property between a master disk and a slave disk in the magnetic transfer process. Japanese Unexamined Patent Application Publication No. 2003-203332 discloses a method in which ferromagnetic regions and nonmagnetic regions isolated from the ferromagnetic regions are formed as a pattern on the surface of a continuous magnetic layer without interruption, substantially eliminating surface irregularities. The method is asserted to ensure recording of preformat information signals on a magnetic recording medium. According to descriptions in these documents, high density magnetic transfer can be ensured.

However, there is a technical problem in the magnetic transfer process that a soft magnetic layer provided on a master disk for signal transfer from a master disk to a slave disk needs physical properties including a high saturation magnetic flux density, a high permeability, and a low coercivity. In addition, configurational conditions about each magnetic part and nonmagnetic part in the pattern on the soft magnetic layer surface of a master disk are known that a planar shape of each part is preferably a rectangular shape and a thickness of each part is preferably as nearly the same as a bit size. In order to meet the conditions for material properties and the conditions for the configuration, materials suited for the conditions must be selected and a micro machining technology is established applicable to the materials. It is not until the necessary technologies are attained that a master disk for magnetic transfer with good transfer performance can be obtained. As for a transferring apparatus, it is preferable to enhance adhesiveness between the master disk and the slave disk in view of transfer performance, on the one hand. When the process of pressing for adhesion and a further process of exhaustion are conducted in a chamber structure, it becomes very difficult to peel off the slave disk from the master disk after the transfer process. The peeling difficulty is in inverse proportion to the improvement in the adhesiveness during transfer.

The present invention is directed to overcoming or at least reducing the effects of one or more of the problems set forth above.

### SUMMARY OF THE INVENTION

In view of the above described problems, the present invention provides a method of manufacturing a master disk possessing ease of transfer. The invention further provides a method of manufacturing a magnetic recording medium in which the two disks can be peeled off easily even after conducting a magnetic transfer process in which two disks are adhered together by pressing or exhaustion for the purpose of enhancing transfer performance. The present invention allows servo information and the like to be recorded by the collective transfer at a low cost.

A method of manufacturing a master information carrier for magnetic transfer according to the present invention comprises steps of: forming a soft magnetic layer uniformly on a surface of a substrate; forming recesses by eliminating selected parts of a surface region of the soft magnetic layer to a depth not to cut apart the parts with one another; and transforming the recessed parts to nonmagnetic or low magnetic; the steps forming a pattern of protrusions and recesses corresponding to information to be magnetically transferred, and the protrusions being magnetic and the recessed parts being nonmagnetic or low magnetic.

Preferably, the soft magnetic layer is composed of a magnetic material of mainly FeCo. Also, the step of transforming the recessed parts to nonmagnetic or low magnetic preferably is carried out by exposing the parts to a gas capable of degrading magnetic properties. The gas capable of degrading magnetic properties is CF₄ gas and the step of transforming the recessed parts into nonmagnetic or low magnetic is carried out by a dry etching method using the CF₄ gas.

A master disk used for magnetic transfer does not have necessarily a magnetic layer that is machined to a pattern of protrusions and recesses completely separated with each other, but only have such a pattern of protrusions and recesses that transfers a transferring pattern corresponding to transfer information onto the slave disk by a magnetic field in the transfer process without failure.

Consequently, a master disk for transfer is obtained which does not require a machining step on the magnetic layer to form protrusions and recesses completely separated with each other, but by machining to form protrusions and recesses by shallow etching on the outermost surface portion of the magnetic layer and then selectively transforming solely the recesses into nonmagnetic or low magnetic state to magnetically provide the master disk with magnetic parts and nonmagnetic or low magnetic parts.

It is preferable in the method of the invention that a means for degrading magnetic properties of the transfer magnetic disk is to expose the parts to be degraded to CF₄ gas or the like by means of a dry etching apparatus.

In another embodiment, a method of manufacturing a magnetic recording medium according to the present invention comprises a step of adhering a master information carrier for magnetic transfer manufactured by the method as defined above and a magnetic recording medium to be transferred; and a step of transferring magnetically the information corresponding to the pattern of protrusions and recesses to the magnetic recording medium to be transferred by applying a transferring magnetic field to the master information carrier for magnetic transfer and the magnetic recording medium to be transferred adhered together.

The present invention provides a method of manufacturing a master disk for ease of transfer. The method of the invention also provides a method of manufacturing a magnetic recording medium in which the two disks can be peeled off easily even after conducting a magnetic transfer process with the both disks adhered together by pressing or exhaustion for the purpose of enhancing transfer performance. The present invention further provides a method of manufacturing a magnetic recording medium in which the servo information and the like are recorded by the collective transfer at a low cost.

### BRIEF DESCRIPTION OF THE DRAWINGS

The foregoing advantages and features of the invention will become apparent upon reference to the following detailed description and the accompanying drawings, of which:

FIG. 1(a) is a plan view of a master disk used in conventional magnetic transfer;

FIG. 1(b) is a sectional view cut along the line A-A in FIG. 1(a);

FIG. 1(c) is a sectional view of the master disk and a slave disk in an adhered state showing conventional magnetic transfer;

FIG. 2(a) is a plan view of a master disk for magnetic transfer in an embodiment according to the present invention;

FIG. 2(b) is a sectional view cut along the line B-B in FIG. 2(a);

FIG. 2(c) is a sectional view of the master disk and a slave disk in an adhered state showing magnetic transfer in an embodiment according to the present invention;

FIGS. 3(a), 3(b), 3(c), and 3(d) are sectional views showing main manufacturing steps in a conventional method of manufacturing a master disk used in magnetic transfer; and

FIGS. 4(a), 4(b), 4(c), and 4(d) are sectional views showing main manufacturing steps in a method of manufacturing a master disk used in magnetic transfer in an embodiment according to the present invention.

### DETAILED DESCRIPTION OF SPECIFIC EMBODIMENTS

Now, some preferred embodiments of a method of manufacturing a master information carrier for magnetic transfer and a method of manufacturing a magnetic recording medium in detail in the following with reference to accompanying drawings, including description on the conventional examples for comparison. The present invention is, however, not limited to the embodiment described below as long as within the scope and spirit of the present invention.

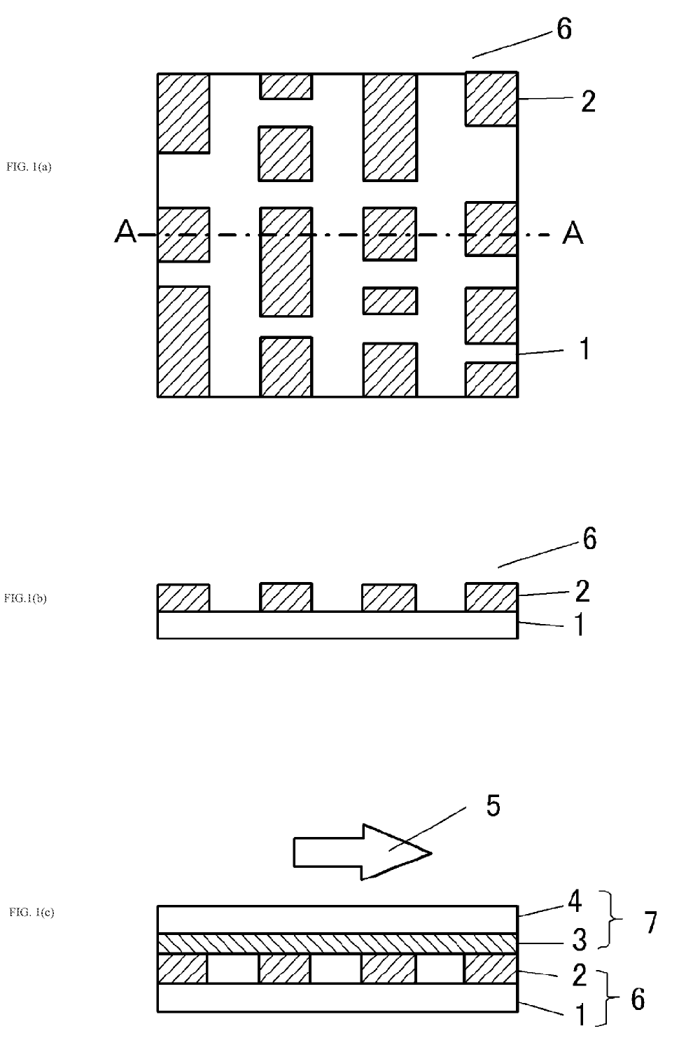

FIG. 1(a) is a plan view of an essential part of a master disk used in a conventional magnetic transfer process, in which the hatched parts are magnetic parts patterned on a nonmagnetic substrate 1. FIG. 1(b) is a sectional view cut along the line A-A in FIG. 1(a).

In the conventional magnetic transfer process, master disk 6 and slave disk 7 are set in a configuration as shown in FIG. 1(c). The surface of magnetic layer 3 formed on slave disk substrate 4 (note that slave disk 7 is drawn upside down,) is made in contact with the surface of soft magnetic layer 2 formed on the master disk surface and adhered with a predetermined pressure.

In the state in which magnetic layer 3 of slave disk 7 and soft magnetic layer 2 of master disk 6 are adhered with one another, transferring magnetic field 5 is applied by a magnetic field generating means (not illustrated) to transfer the servo information written in a pattern of protrusions and recesses formed in soft magnetic layer 2 of master disk 6 to the surface of magnetic layer 3 of slave disk 7.

Magnetic transfer using master disk 6 is conducted on one surface side of slave disk 7 in contact with a master disk as in the case illustrated in FIG. 1(c). However, simultaneous transfer on both surfaces of the slave disk can also be conducted with a pair of master disks 6 adhered to the both surfaces of the slave disk, though not illustrated.

A transferring magnetic field is applied by a magnetic field generating means to a rotating integration of slave disk 7 and master disk 6 to magnetically transfer the information held in the pattern of protrusions and recesses on master disk 6 to magnetic layer 3 of slave disk 7.

Another construction is also possible in which a magnetic field generating means is rotated.

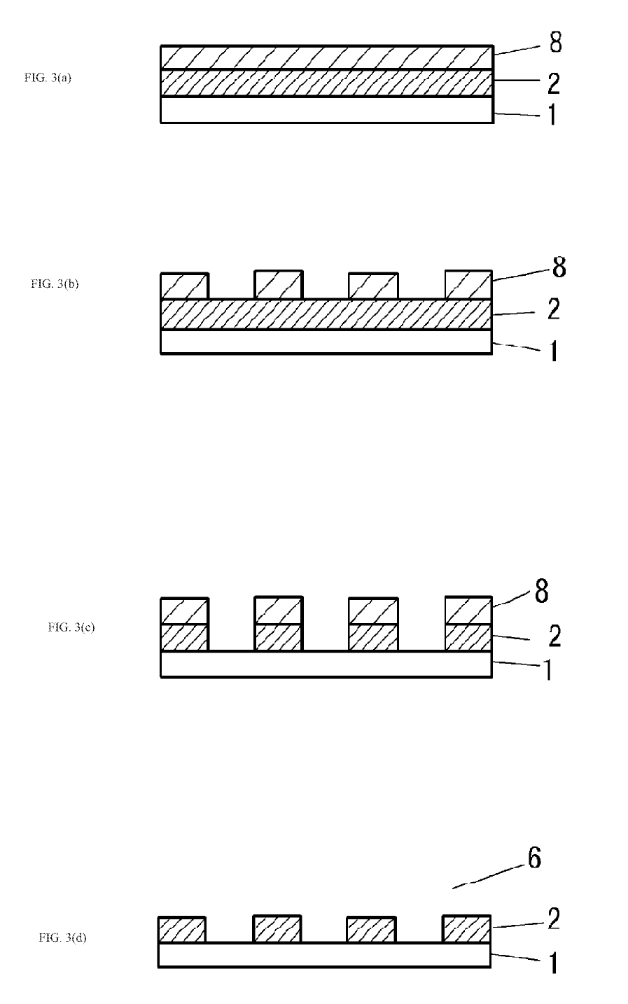

FIGS. 3(a) through 3(d) illustrate the main steps of manufacturing master disk 6 for conventional magnetic transfer. First, as shown in FIG. 3(a), nonmagnetic material substrate 1 with a smooth and clean surface is prepared, which can be a nonmagnetic substrate of silicon, glass, quartz, or the like. Soft magnetic layer 2 is formed by depositing a soft magnetic substance such as FeCo by sputtering to obtain a magnetic film for magnetic transfer. After a preliminary treatment to improve adhering performance of a resist film formed in the next step, an electron beam resist solution is applied by means of a spin-coating method or the like to form resist film 8.

Then as shown in FIG. 3(b), an electron beam is irradiated on resist film 8 on material substrate 1 mounted on a stage of an electron beam exposure apparatus (not shown). The electron beam exposure apparatus is provided with a turning stage or an X-Y stage capable of high precision irradiation and irradiates an electron beam that is modulated corresponding to desired servo signals. Thus, exposure drawing is carried out to create a patter having openings corresponding to the servo signals on resist film 8, followed by a development process.

Although the resist pattern is formed by means of an electron beam writing method, another method, for example, an imprinting method can also be employed for forming a resist pattern. In that case, a resist pattern with the openings is not formed, but a resist pattern of protrusions and recesses with different thicknesses of resist film is formed.

Then, as shown in FIG. 3(c), soft magnetic layer 2 is partly removed using the pattern in resist film 8 as a mask by a machining technique of an RIE dry etching method using a reactive gas or an ion milling method using argon gas, to completely separate the protrusions in soft magnetic layer 2 from one another. Finally, as shown in FIG. 3(d), resist film 8 is removed by an oxygen plasma etching method or a method using a peeling solution for the resist. Through the photolithography process as describe above, conventional master disk 6 is produced having a pattern of protrusions and recesses corresponding to the servo information formed in soft magnetic layer 2.

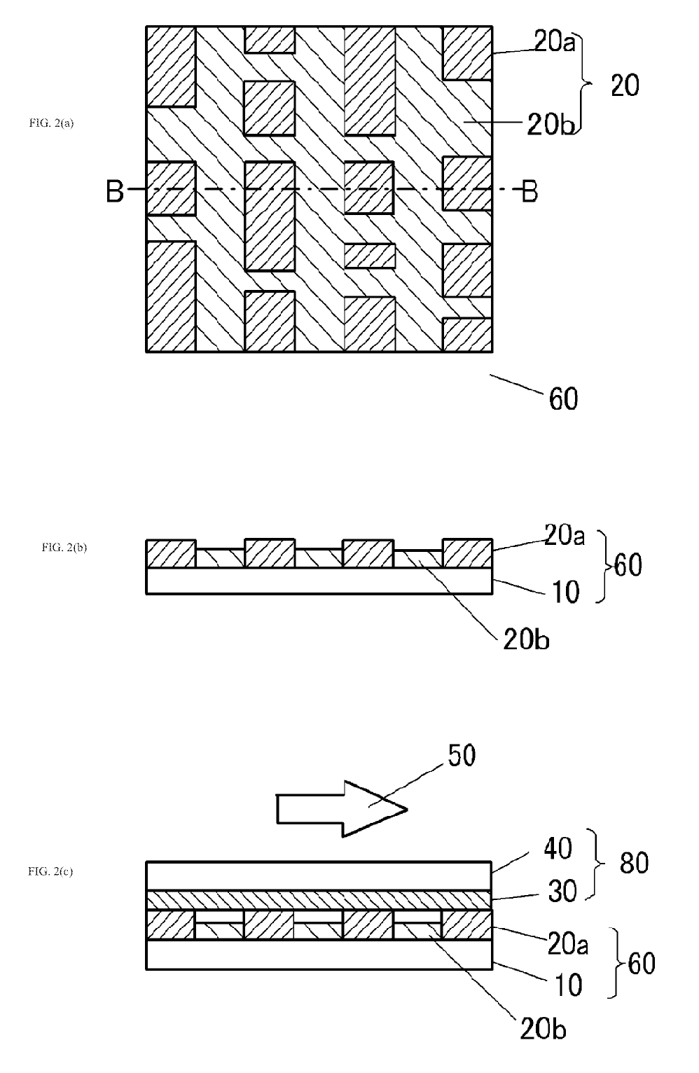

Now, description will be made of a method of manufacturing a master disk for magnetic transfer and a method of magnetic transfer according to the present invention. FIG. 2(a) is a plan view of an essential part of a master disk in the method of magnetic transfer according to the invention. FIG. 2(b) is a sectional view of the essential part of the master disk in the method of magnetic transfer of the invention. FIG. 2(c) is a sectional view of the essential parts of the master disk and the slave disk adhered with one another. FIG. 2(a) is a plan view showing a part of master disk 60, and the hatched regions indicate protrusions of high magnetic regions 20a in patterned soft magnetic layer 20 on nonmagnetic substrate 10. FIG. 2(b) is a sectional view cut along the line B-B in FIG. 2(a).

Symbol 20b indicates recesses of low magnetic parts in soft magnetic layer 20, the low magnetic regions are subjected to exposure of CF₄ gas on the surface thereof to degrade the magnetic property. The low magnetic parts 20b can be transformed to nonmagnetic regions. The recesses regions can be formed by reducing the thickness in some extent before exposing to the CF₄ gas. The exposure to the CF₄ gas is useful also in that case because of little more elimination of the exposed surface.

In the transfer process, master disk 60 and slave disk 80 are set in a configuration as shown in FIG. 2(c). The surface of magnetic layer 30 formed on slave disk substrate 40 (note that slave disk 80 is drawn upside down,) is made in contact with the surface of soft magnetic layer 20 formed on the master disk surface and adhered with a predetermined pressure. In the state in which magnetic layer 30 of slave disk 80 and soft magnetic layer 20 of master disk 60 adhered with one another, transferring magnetic field 50 is applied by a magnetic field generating means (not illustrated) to transfer the servo information corresponding to the pattern of protrusions and recessed on master disk 60 to the surface (a magnetic recording surface) of magnetic layer 30 of slave disk 80.

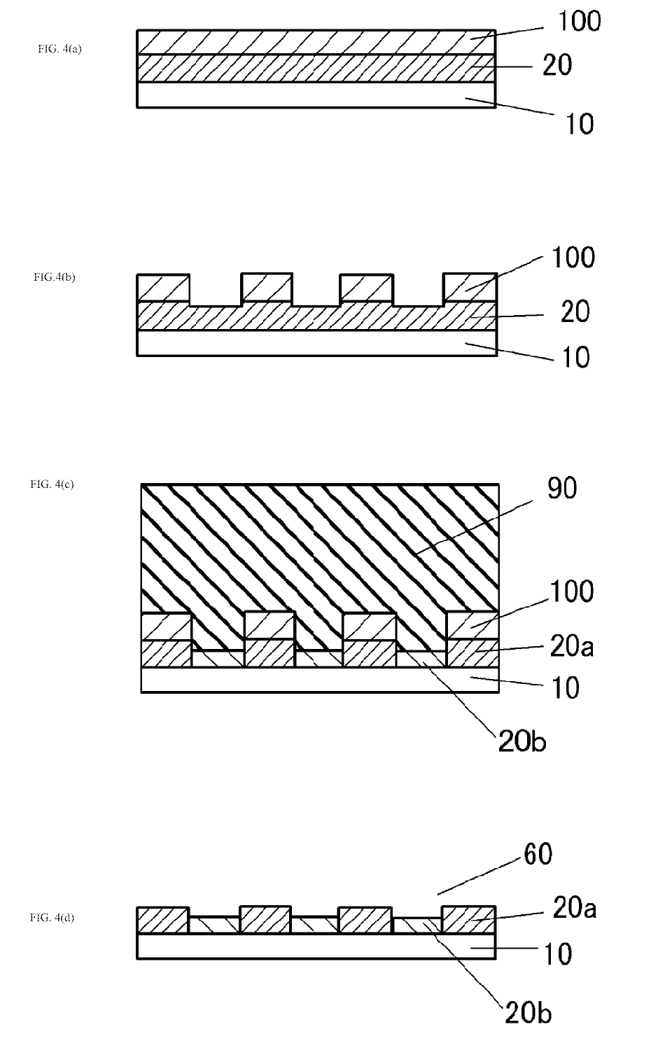

FIGS. 4(a) through 4(d) illustrate main steps of manufacturing master disk 60 for magnetic transfer according to the manufacturing method of the invention. First, as shown in FIG. 4(a), a nonmagnetic material substrate 10 with a smooth and clean surface is prepared, which can be a nonmagnetic substrate of silicon, glass, quartz or the like. Soft magnetic layer 20 is formed by depositing a soft magnetic substance such as FeCo by sputtering to obtain a magnetic film for magnetic transfer. After a preliminary treatment on the surface of soft magnetic layer 20, a resist solution is applied on the surface of soft magnetic layer 20 by means of a spin-coating method or the like to form resist film 100.

Then, as shown in FIG. 4(b), an electron beam is irradiated on resist film 100 on magnetic layer 20 formed on material substrate 10 mounted on a stage of an electron beam exposure apparatus (not shown). The electron beam exposure apparatus is provided with a turning stage or an X-Y stage capable of high precision irradiation and irradiates an electron beam that is modulated corresponding to desired servo signals. Thus, exposure drawing is carried out to create a pattern having openings corresponding to the servo signals on resist film 100, followed by a development process. Soft magnetic layer 20 can be processed to form recesses with a depth of several nm by means of an RIE dry etching method using a reactive gas or an ion milling method using argon gas.

Then, as shown in FIG. 4(c), an exposure to CF gas is conducted in a dry etching apparatus using the pattern in resist film 100 as a mask in the conditions of a power of 100 to 400 W, a gas flow rate of 10 to 100 sccm, a pressure of 1.0 to 3.0 Pa, and to time duration of 60 to 300 sec.

This exposure to the CF₄ gas forms low magnetic parts 20b at places in soft magnetic layer 20 not masked by resist film 100. In low magnetic parts 20b, micro structure of the FeCo crystal is disordered and the coercivity is degraded to about half or smaller in comparison with the coercivity before the exposure process.

At the same time, the exposure process to the CF₄ gas slightly (in several nm) eliminates the surface regions of the uncovered parts of soft magnetic layer 20 to create recessed parts. Although low magnetic parts 20b is favorably thoroughly nonmagnetic, the coercivity degraded down to half or less is sufficient to prevent adverse effect on precision.

Then as shown in FIG. 4(d), resist film 100 is removed by an oxygen plasma etching method or a method using a peeling solution for the resist. Through the procedure as described above, master disk 60 is produced having a magnetic pattern corresponding to the servo information.

As described above, the etching process on the soft magnetic layer of a master disk in the method of the invention is carried out in a short time as compared with a conventional method in which a process to generate a pattern of protrusions and recesses thoroughly separated with one another in the soft magnetic layer. Therefore, a master disk is manufactured by a relatively easy technology.

Since the surface of the soft magnetic layer is partly eliminated slightly, it is easy to transform the parts to a low magnetic state. Since the recessed parts are formed between the protruding parts on the surface of the master disk, a magnetic transfer process can be performed maintaining gaps between the adhered master disk and the slave disk.

As a result, the master disk and the slave disk can be separated easily without any special mechanism. Therefore, a transfer device requires no special mechanism or restriction other than a mechanism for pressing to adhere the master disk and the slave disk.

A transfer device is much simpler than in the convention magnetic transfer, and the separation of the slave disk from the master disk can be carried out easily. Therefore, the servo information and the like on the master disk are transferred to a slave disk at a low cost.

Thus, a master information carrier for magnetic transfer and a method of manufacturing the same have been described according to the present invention. Many modifications and variations may be made to the techniques and structures described and illustrated herein without departing from the spirit and scope of the invention. Accordingly, it should be understood that the [methods and apparatus] described herein are illustrative only and are not limiting upon the scope of the invention.

This application is based on and claims priority to Japanese Patent Application 2009-157893, filed on Jul. 2, 2009. The disclosure of the priority application in its entirety, including the drawings, claims, and the specification thereof, is incorporated herein by reference.

### DESCRIPTION OF SYMBOLS

1, 10: master disk substrate
2, 20: soft magnetic layer
20a: magnetic part
20b: nonmagnetic or low magnetic part
3, 30: magnetic layer
4, 40: slave disk substrate
5, 50: transferring magnetic field
6. 60: magnetic disk
7, 80: slave disk
8: resist film
90: CF₄ gas
100: resist film

What is claimed is:

1. A method of manufacturing a master information carrier for magnetic transfer comprising:
forming a soft magnetic layer uniformly on a surface of a substrate;
forming recesses by eliminating selected parts of a surface region of the soft magnetic layer to a depth less than the depth of the soft magnetic layer; and
transforming the recessed parts to nonmagnetic or low magnetic;
thereby producing a pattern of protrusions and recesses corresponding to information to be magnetically transferred, wherein the protrusions are magnetic and the recessed parts are nonmagnetic or low magnetic.

2. The method of manufacturing a master information carrier for magnetic transfer according to claim 1, wherein the soft magnetic layer is composed of a magnetic material comprising primarily FeCo.

3. The method of manufacturing a master information carrier for magnetic transfer according to claim 1, wherein the step of transforming the recessed parts to nonmagnetic or low magnetic is carried out by exposing the parts to a gas capable of degrading magnetic properties.

4. The method of manufacturing a master information carrier for magnetic transfer according to claim 3, wherein the gas capable of degrading magnetic properties is CF₄ gas and the step of transforming the recessed parts into nonmagnetic or low magnetic is carried out by a dry etching method using the CF₄ gas.

5. A method of manufacturing a magnetic recording medium comprising:
adhering a master information carrier for magnetic transfer manufactured by the method as defined by claim 1 and a magnetic recording medium; and
applying a transferring magnetic field to the master information carrier to magnetically transfer the information corresponding to the pattern of protrusions and recesses thereon to the adhered magnetic recording medium.
